(19) United States
(12) Patent Application Publication
(10) Pub. No.: US 2019/0030822 A1
(43) Pub. Date: Jan. 31, 2019

(54) THREE-DIMENSIONAL MOLDING DEVICE, METHOD FOR CONTROLLING SAME, AND ARTICLE MOLDED BY SAME

(71) Applicant: MUTOH INDUSTRIES LTD., Tokyo (JP)

(72) Inventor: Takashi TOUMA, Tokyo (JP)

(73) Assignee: MUTOH INDUSTRIES LTD., Tokyo (JP)

(21) Appl. No.: 16/072,340

(22) PCT Filed: Nov. 7, 2016
(86) PCT No.: PCT/JP2016/082974

§ 371 Date: Jul. 24, 2018

(30) Foreign Application Priority Data
Jan. 25, 2016 (JP) 2016-011899

(51) Int. Cl. B29C 64/393; B29C 64/118; B29C 64/20; B33Y 10/00; B33Y 30/00; B33Y 50/02

(52) U.S. Cl. CPC B29C 64/393; B29C 64/118; B33Y 50/02; B33Y 10/00; B33Y 30/00; B29C 64/20

(57) ABSTRACT

A molded article has a repeated structure of a first layer and a second layer, wherein the first layer has a resin material that continuously extends in a first direction, the second layer provided above the first layer has a resin material that continuously extends in a second direction intersecting the first direction, and the resin material of the first layer and the resin material of the second layer extend, at their intersection, in a third direction that intersects at least one of the first direction and the second direction.

### TECHNICAL FIELD

The present invention relates to a three-dimensional molding device, a method for controlling the same, and an article molded by the same.

### BACKGROUND ART

A three-dimensional molding device that manufactures a molded article based on three-dimensional design data is known by, for example, Patent Document 1. As systems of this kind of three-dimensional molding device, various systems, such as an optical molding method, a powder sintering method, an ink jet method, and a molten resin extrusion molding method have been proposed and made into products.

As an example, in a three-dimensional molding device adopting the molten resin extrusion molding method, a molding head for discharging a molten resin that is to be a material of a molded article is mounted on a three-dimensional moving mechanism, and the molding head is moved in three-dimensional directions to laminate the molten resin while discharging the molten resin, thereby obtaining the molded article. In addition, a three-dimensional molding device adopting the ink jet method also has a structure in which a molding head for dripping a heated thermoplastic material is mounted on a three-dimensional moving mechanism.

In such three-dimensional molding devices, it is important to increase adhesion of resins at a joint of upper and lower layers.

### PRIOR ART DOCUMENT

### Patent Document

Patent Document 1: JP 2002-307562 A

### DISCLOSURE OF INVENTION

### Problem to be Solved by the Invention

The present invention has an article of providing a three-dimensional molding device in which adhesion of fellow resin materials has been increased, a method for controlling the same, and an article molded by the same.

### Means for Solving the Problem

A molded article according to the present invention has a repeated structure of a first layer and a second layer, wherein the first layer has a resin material that continuously extends in a first direction overall, the second layer provided above the first layer has a resin material that continuously extends in a second direction intersecting the first direction overall, and the resin material of the first layer and the resin material of the second layer extend, at their intersection, in a third direction that intersects at least one of the first direction and the second direction.

In addition, a molded article according to the present invention has a repeated structure of a first layer and a second layer that include a plurality of kinds of resin materials, wherein the first layer has a first resin material that continuously extends in a first direction overall, and is arranged with a gap in a second direction intersecting the first direction, and a second resin material other than the first resin material, continuously extends in the first direction overall, and includes a portion arranged in the gap, the second layer provided above the first layer has the first resin material that continuously extends in a third direction intersecting the first direction, and is arranged with a gap in a fourth direction intersecting the third direction, and the second resin material that continuously extends in the third direction, and includes a portion arranged in the gap, the first resin material of the first layer and the first resin material of the second layer extend, at their intersection, in a fifth direction that intersects at least one of the first direction and the third direction, and the second resin material of the first layer and the second resin material of the second layer extend, at their intersection, in a sixth direction that intersects at least one of the first direction and the third direction.

A method of controlling a three-dimensional molding device according to the present invention is a method of controlling a three-dimensional molding device that includes a molding head. This method includes the steps of: controlling the molding head such that, in a first layer, a resin material continuously extends in a first direction overall; and controlling the molding head such that, in a second layer provided above the first layer, the resin material continuously extends in a second direction intersecting the first direction overall, wherein control is performed such that the resin material of the first layer and the resin material of the second layer extend, at their intersection, in a third direction that intersects at least one of the first direction and the second direction.

In addition, a method of controlling a three-dimensional molding device that includes a molding head includes the steps of: controlling the molding head such that, in a first layer, a first resin material continuously extends in a first direction and is arranged with a gap in a second direction intersecting the first direction, and a second resin material other than the first resin material continuously extends in the first direction and is arranged in the gap; and controlling the molding head such that, in a second layer provided above the first layer, the first resin material continuously extends in a third direction intersecting the first direction, and is arranged with a gap in a fourth direction intersecting the third direction, wherein control is performed such that the first resin material of the first layer and the first resin material of the second layer extend, at their intersection, in a fifth direction that intersects at least one of the first direction and the third direction, and includes the step of controlling the molding head such that, in the second layer provided above the first layer, the second resin material is arranged in the gap so as to continuously extend in the third direction overall, wherein control is performed such that the second resin material of the first layer and the second resin material of the second layer extend, at their intersection, in a sixth direction that intersects at least one of the first direction and the third direction.

A three-dimensional molding device according to the present invention includes: a molding stage on which a molded article is placed; a raising-and-lowering section which is movable in at least a perpendicular direction with respect to the molding stage; a molding head which is mounted in the raising-and-lowering section and receives supply of a resin material; and a control section that controls the raising-and-lowering section and the molding head. The control section controls the molding head such that, in a first layer, the resin material continuously extends in a first direction overall, and the control section further controls the molding head such that, in a second layer provided above the first layer, the resin material continuously extends in a second direction intersecting the first direction overall, and such that the resin material of the first layer and the resin material of the second layer extend, at their intersection, in a third direction that intersects at least one of the first direction and the second direction.

In addition, a three-dimensional molding device according to the present invention includes: a molding stage on which a molded article is placed; a raising-and-lowering section which is movable in at least a perpendicular direction with respect to the molding stage; a molding head which is mounted in the raising-and-lowering section and receives supply of a plurality of kinds of resin materials which are different from each other; and a control section that controls the raising-and-lowering section and the molding head. The control section controls the molding head such that, in a first layer, a first resin material of the plurality of kinds of resin materials continuously extends in a first direction overall, and is arranged with a gap in a second direction intersecting the first direction, and such that a second resin material other than the first resin material of the plurality of kinds of resin materials continuously extends in the first direction overall and is arranged in the gap, controls the molding head such that, in a second layer provided above the first layer, the first resin material continuously extends in a third direction intersecting the first direction overall, and is arranged with a gap in a fourth direction intersecting the third direction, and such that the second resin material continuously extends in the third direction overall and is arranged in the gap, and controls the molding head such that the first resin material of the first layer and the first resin material of the second layer extend, at their intersection, in a fifth direction that intersects at least one of the first direction and the third direction, and the second resin material of the first layer and the second resin material of the second layer extend, at their intersection, in a sixth direction that intersects at least one of the first direction and the third direction.

### BRIEF DESCRIPTION OF DRAWINGS

FIG. 1 is a perspective view showing a schematic configuration of a three-dimensional molding device according to a first embodiment.

FIG. 2 is a front view showing a schematic configuration of the three-dimensional molding device according to the first embodiment.

FIG. 3 is a perspective view showing a configuration of an XY stage 12.

FIG. 4 is a plan view showing a configuration of a raising-and-lowering table 14.

FIG. 5 is a functional block diagram showing a configuration of a computer 200 (control device).

FIG. 6 is a plan view showing an example of a structure of a molded article S formed according to the first embodiment.

FIG. 7 is a plan view showing another example of a structure of the molded article S formed according to the first embodiment.

FIG. 8A is a plan view showing another example of a structure of the molded article S formed according to the first embodiment.

FIG. 8B is a plan view showing another example of a structure of the molded article S formed according to the first embodiment.

FIG. 8C is a plan view showing another example of a structure of the molded article S formed according to the first embodiment.

FIG. 9 is a plan view showing an example of a structure of a molded article S formed according to a second embodiment.

FIG. 10A is a process drawing showing a manufacturing step of the molded article S shown in FIG. 8 according to the second embodiment.

FIG. 10B is a process drawing showing a manufacturing step of the molded article S shown in FIG. 8 according to the second embodiment.

FIG. 10C is a process drawing showing a manufacturing step of the molded article S shown in FIG. 8 according to the second embodiment.

FIG. 10D is a process drawing showing a manufacturing step of the molded article S shown in FIG. 8 according to the second embodiment.

FIG. 11 is a perspective view showing another example of a structure of the molded article S formed according to the second embodiment.

FIG. 12 is a plan view showing another example of a structure of the molded article S formed according to the second embodiment.

FIG. 13 is a flowchart showing a procedure of molding by the three-dimensional molding device of the second embodiment.

FIG. 14 is a conceptual diagram showing the procedure of molding by the three-dimensional molding device of the second embodiment.

### EMBODIMENTS FOR CARRYING OUT THE INVENTION

Next, embodiments of the present invention will be described in detail with reference to the drawings.

### First Embodiment

(Overall Configuration)

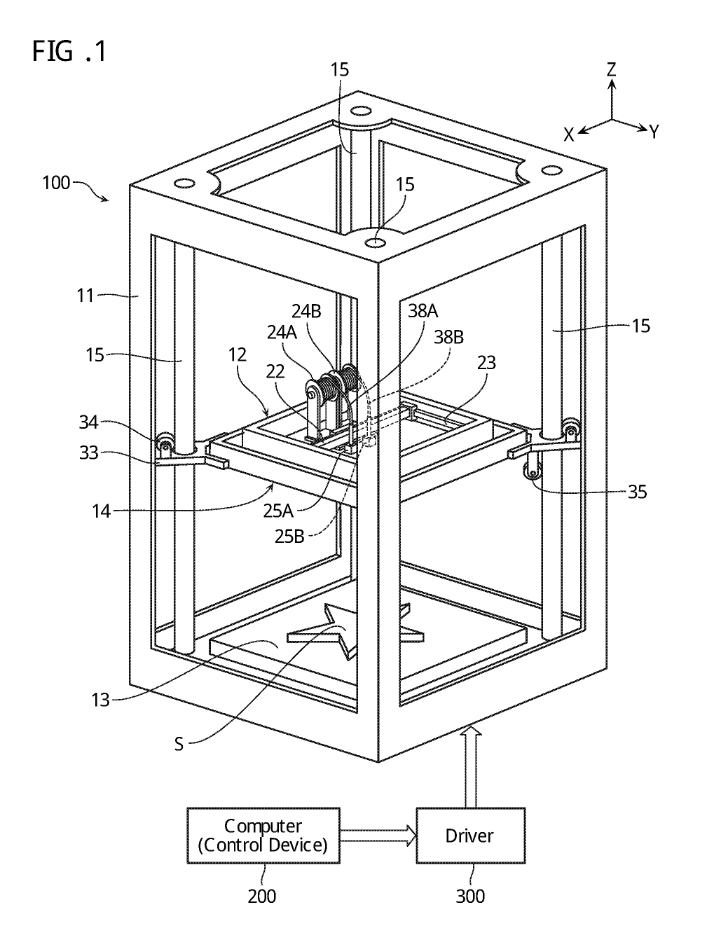

FIG. 1 is a perspective view showing a schematic configuration of a 3D printer 100 employed in a first embodiment. The 3D printer 100 includes a frame 11, an XY stage 12, a molding stage 13, a raising-and-lowering table 14, and guide shafts 15.

A computer 200 acting as a control device that controls this 3D printer 100 is connected to this 3D printer 100. Moreover, a driver 300 for driving various kinds of mechanisms in the 3D printer 100 is also connected to this 3D printer 100.

(Frame 11)

As shown in FIG. 1, the frame 11 has a rectangular parallelepiped external form, for example, and includes a framework of a metal material such as aluminum. Four of the guide shafts 15, for example, are formed in four corners of this frame 11, so as to extend in a Z direction (an up-down direction) of FIG. 1, that is, a direction perpendicular to a plane of the molding stage 13. Each of the guide shafts 15 is a linear member defining a direction that the raising-and-lowering table 14 is moved in the up-down direction as will be mentioned later. The number of guide shafts 15 is not limited to four, and is set to a number enabling the raising-and-lowering table 14 to be stably supported and moved.

(Molding Stage 13)

The molding stage 13 is a platform on which a molded article S is placed, and is a platform where a resin discharged from a later-mentioned molding head is deposited.

(Raising-and-Lowering Table 14)

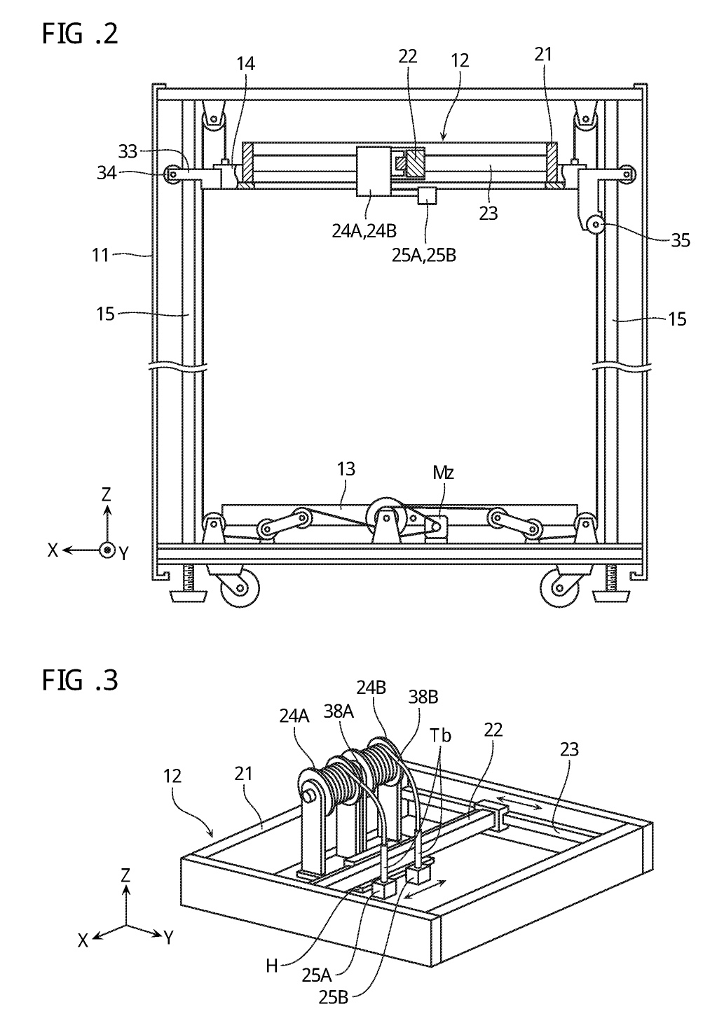

As shown in FIGS. 1 and 2, the raising-and-lowering table 14 (raising-and-lowering section) is penetrated at its four corners by the guide shafts 15, and is configured movably along a longitudinal direction (Z direction) of the guide shafts 15. The raising-and-lowering table 14 includes rollers 34, 35 that contact the guide shafts 15. The rollers 34, 35 are installed rotatably in arm sections 33 formed in two corners of the raising-and-lowering table 14. These rollers 34, 35 rotate while making contact on the guide shafts 15, whereby the raising-and-lowering table 14 is enabled to move smoothly in the Z direction. In addition, as shown in FIG. 2, a drive force of a motor Mz is transmitted by a power transmission mechanism configured from the likes of a timing belt, a wire, and a pulley, whereby the raising-and-lowering table 14 moves in certain intervals (for example, a pitch of 0.1 mm) in the up-down direction. The motor Mz is preferably the likes of a servomotor or a stepping motor, for example. Note that by employing an unillustrated position sensor to measure a position in a height direction of the actual raising-and-lowering table 14 continuously or intermittently in real time, and making an appropriate correction, it is possible to configure such that positional precision of the raising-and-lowering table 14 is enhanced. The same applies also to later-mentioned molding heads 25A, 25B.

(XY Stage 12)

The XY stage 12 is placed on an upper surface of the raising-and-lowering table 14. FIG. 3 is a perspective view showing a schematic configuration of this XY stage 12. The XY stage 12 includes a frame body 21, an X guide rail 22, a Y guide rail 23, reels 24A, 24B, the molding heads 25A, 25B, and a molding head holder H. The X guide rail 22 has its both ends fitted to the Y guide rail 23, and is held slidably in the Y direction. The reels 24A, 24B are fixed to the molding head holder H, and move in XY directions following movement of the molding heads 25A, 25B held by the molding head holder H. A thermoplastic resin that will be a material of the molded article S is a string-molded resin (filaments 38A, 38B) having a diameter of about 3 to 1.75 mm, and is usually held in a wound state in the reels 24A, 24B, but during molding, is fed into the molding heads 25A, 25B by a later-mentioned motor (extruder) provided in the molding heads 25A, 25B.

Note that it is also possible to adopt a configuration in which the reels 24A, 24B are fixed to the likes of the frame body 21 without being fixed to the molding head holder H, and are not made to follow movement of the molding heads 25. Moreover, although a configuration has been adopted in which the filaments 38A, 38B are fed in an exposed state into the molding heads 25, it is also possible for the filaments 38A, 38B to be fed into the molding heads 25A, 25B mediated by a guide (for example, a tube, a ring guide, and so on). Note that, as will be mentioned later, the filaments 38A, 38B may be configured from the same resin material, or may each be configured from a different resin material. As an example, in the case that one is any of an ABS resin, a polypropylene resin, a nylon resin, and a polycarbonate resin, the other can be configured as a resin other than the any one of those resins. Alternatively, it is also possible to configure such that even if the filaments 38A, 38B are of the same resin material, kinds or proportions of materials of fillers included on their insides differ. That is, the filaments 38A, 38B may each have a different property, and, by their combination, allow characteristics (strength, and so on) of the molded article to be improved.

Note that in FIGS. 1 to 3, the molding head 25A is configured to melt and discharge the filament 38A, the molding head 25B is configured to melt and discharge the filament 38B, and independent molding heads are respectively prepared for the different filaments. However, the present invention is not limited to this, and it is possible to adopt also a configuration of the kind where only a single molding head is prepared, and a plurality of kinds of filaments (resin materials) are selectively melted and discharged by the single molding head. Moreover, there may also be a configuration of the kind where only a single molding head is used, and a single filament is melted and discharged to obtain the molded article S. Furthermore, although FIGS. 1 to 3 illustrate the case where two molding heads are provided, it is also possible for three or more molding heads to be adopted. That is, the number of molding heads or the number of kinds of resins used in the filaments may be arbitrarily changed.

A thermoplastic resin is preferably used as the resin material. The following may be cited as the thermoplastic resin, namely, for example, an ABS resin, a polypropylene resin, a nylon resin, a polycarbonate resin, a polyacetal resin, a polyphenylene sulfide resin, and so on. Of those, a crystalline resin (crystalline plastic) including many crystal structures as molecular structures is more preferable, and, in particular, a straight chain aromatic polyester resin obtained by coupling aromatic rings in a straight chain by ester bonds is most preferable. As an example thereof, a straight chain aromatic polyester resin in which p-hydroxybenzoic acid and another component such as biphenyl or ethylene terephthalate have been ester-bonded, that is, a liquid crystal polymer (LCP), may be cited.

The filaments 38A, 38B are fed from the reels 24A, 24B, via tubes Tb, to inside the molding heads 25A, 25B. The molding heads 25A, 25B are held by the molding head holder H, and are configured movably along the X, Y direction guide rails 22, 23, together with the reels 24A, 25B. Moreover, although illustration thereof is omitted in FIGS. 2 and 3, extruder motors for feeding the filaments 38A, 38B downwardly in the Z direction are arranged inside the molding heads 25A, 25B. Although the molding heads 25A, 25B need only be configured capable of moving, along with the molding head holder H, keeping a constant positional relationship with each other in the XY plane, they may also be configured such that their positional relationship with each other may be changed even in the XY plane.

Note that although illustration thereof is omitted in FIGS. 2 and 3, motors Mx, My for moving the molding heads 25A, 25B with respect to the XY table 12 are also provided on this XY stage 12. The motors Mx, My are preferably the likes of servomotors or stepping motors, for example.

(Driver 300)

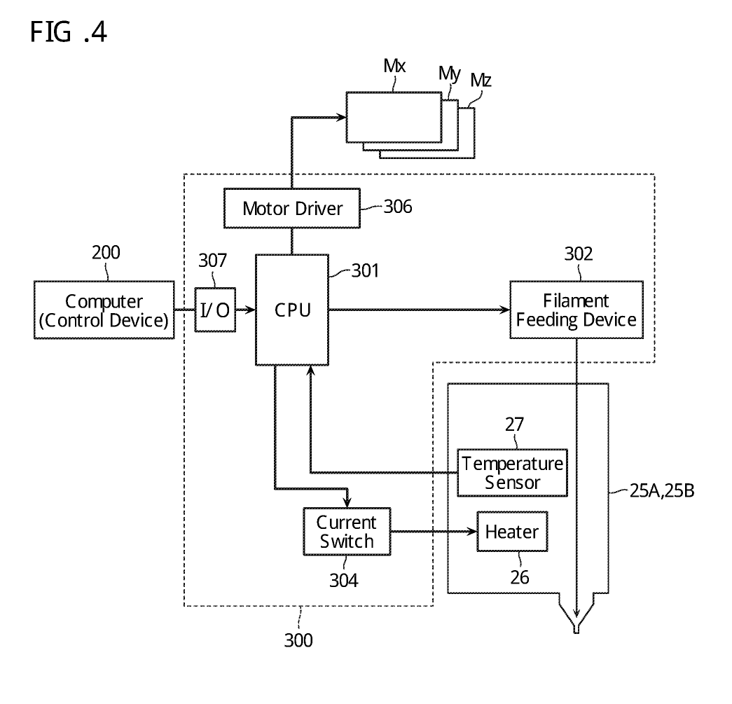

Next, details of a structure of the driver 300 will be described with reference to the block diagram of FIG. 4. The driver 300 includes a CPU 301, a filament feeding device 302, a head control device 303, a current switch 304, and a motor driver 306.

The CPU 301 receives various kinds of signals from the computer 200, via an input/output interface 307, and thereby performs overall control of the driver 300. The filament feeding device 302, based on a control signal from the CPU 301, issues to the extruder motors in the molding heads 25A, 25B commands controlling a feed amount (push-in amount or saving amount) to the molding heads 25A, 25B of the filaments 38A, 38B.

The current switch 304 is a switch circuit for switching an amount of current flowing in a heater 26. By a switching state of the current switch 304 being switched, a current flowing in the heater 26 increases or decreases, whereby temperature of the molding heads 25A, 25B is controlled. Moreover, the motor driver 306, based on a control signal from the CPU 301, generates a drive signal for controlling the motors Mx, My, Mz.

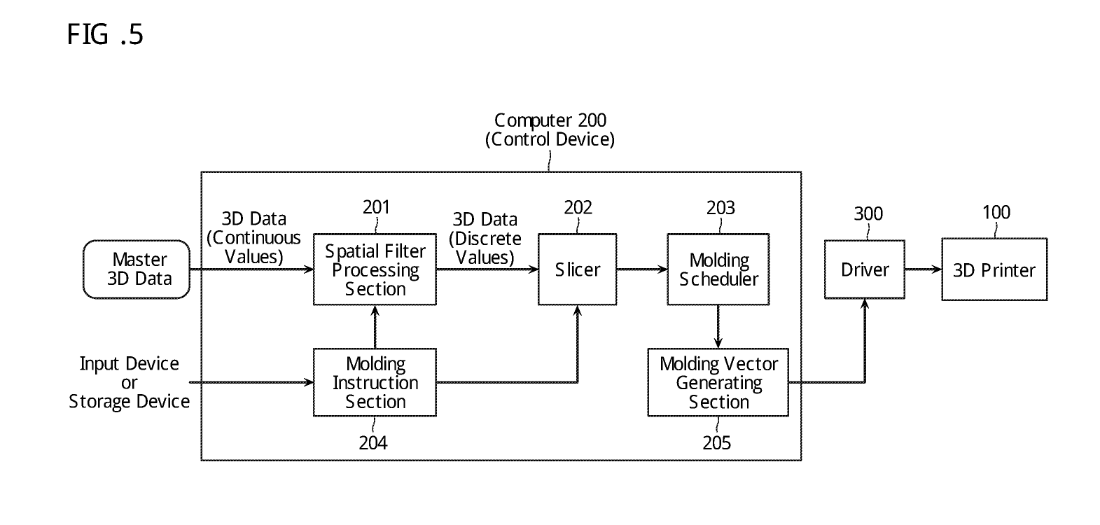

FIG. 5 is a functional block diagram showing a configuration of the computer 200 (control device). The computer 200 includes a spatial filter processing section 201, a slicer 202, a molding scheduler 203, a molding instruction section 204, and a molding vector generating section 205. These configurations can be achieved by a computer program inside the computer 200.

The spatial filter processing section 201 receives, from outside, master 3D data indicating a three-dimensional shape of the molded article which is to be molded, and performs various kinds of data processing on a molding space where the molded article will be formed based on this master 3D data. Specifically, as will be mentioned later, the spatial filter processing section 201 has a function of dividing the molding space into a plurality of molded units Up (x, y, z) as required, and assigning to each of the plurality of molded units Up property data indicating characteristics that should be given to each of the molded units, based on the master 3D data. A necessity of division into molded units or not and a size of the individual molded units are determined by a size and shape of the molded article S to be formed. For example, division into molded units is not required in a case such as when a mere plate is formed.

The molding instruction section 204 provides the spatial filter processing section 201 and the slicer 202 with instruction data relating to content of molding. As an example, the following are included in the instruction data. These are merely exemplary, and it is possible for all of these instructions to be inputted, or only some to be inputted. Moreover, it goes without saying that an instruction differing from matters listed below may be inputted.
(i) Size of one molded unit Up
(ii) Molding order of the plurality of molded units Up
(iii) Kinds of the plurality of kinds of resin materials used in the molded units Up
(iv) Combination ratios (combination ratios) of the resin materials of different kinds in the molded units Up
(v) Direction that resin materials of the same kinds are continuously formed in the molded units Up (hereafter, called “molding direction”)

Note that the molding instruction section 204 may receive input of the instruction data from an input device such as a keyboard or mouse, or may be provided with the instruction data from a storage device storing the molding content.

Moreover, the slicer 202 has a function of converting each of the molded units Up into a plurality of slice data. The slice data is sent to the later-stage molding scheduler 203. The molding scheduler 203 has a role of determining the likes of a molding procedure or the molding direction in the slice data, based on the previously mentioned property data. Moreover, the molding vector generating section 205 generates a molding vector based on the molding procedure and molding direction determined in the molding scheduler 203. Data of the molding vector is sent to the driver 300. The driver 300 controls the 3D printer 100 based on the received data of the molding vector.

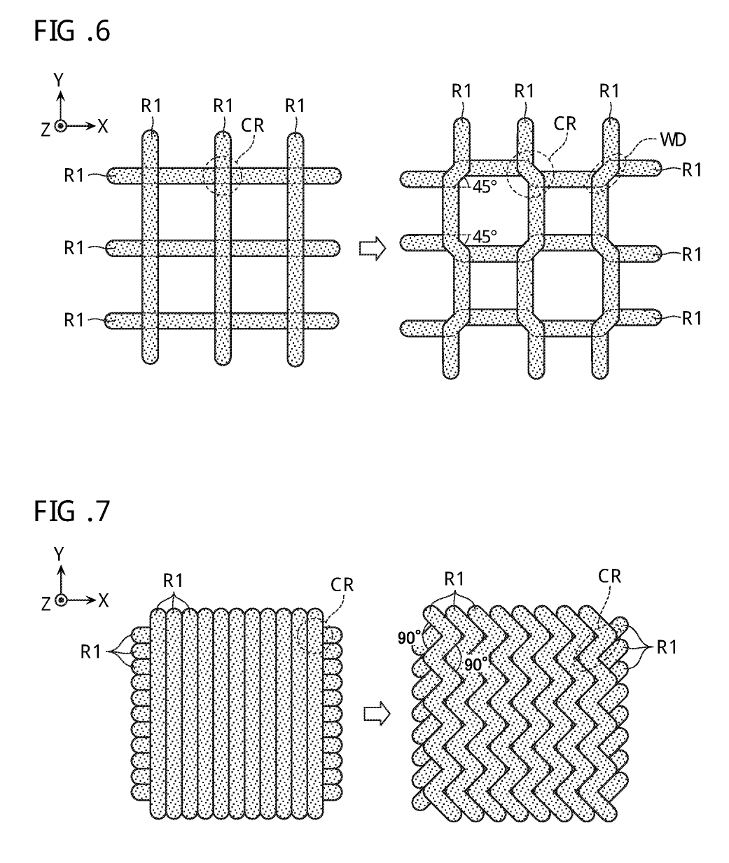

In the three-dimensional molding device of the present embodiment, the control device 200 (a control section) operates such that resin materials of straight chain structure are arranged so that their directions of extension (molding directions) differ every layer, and such that, at intersections where the resin materials of upper and lower layers intersect, fellow resin materials are joined overlapping in parallel. That is, the control device 200 operates such that directions of molecular chains at the intersections of the resin materials match. Now, an intersection does not mean a “point” where the resin materials of the upper and lower layers intersect, but means a region where there is overlapping of fellow portions having a length sufficient to enable the resin materials of the upper and lower layers to adhere. FIGS. 6 and 7 show examples of structures of the molded article S formed by the present embodiment.

FIG. 6 is a plan view showing an example of a structure of the molded article S formed by the first embodiment. As shown on the left side of FIG. 6, in a molded article S manufactured by a conventional three-dimensional molding device, a resin material R1 extends linearly with the X direction (a first direction) as its molding direction in one layer (a first layer), while in a layer one above that layer (a second layer), it extends linearly with the Y direction (a second direction) intersecting the X direction (the first direction) as its molding direction. As a result, the molded article S has a structure (a so-called parallel cross structure) in which fellow resin materials R1 intersect orthogonally to be joined in the up-down direction at intersections CR of the resin materials R1 of the first layer and the second layer.

If, when molding is performed using a crystalline plastic as the resin material, crystal directions differ for the upper and lower layers as shown on the left side of FIG. 6, then since fellow molecular chains intersect, it becomes difficult for crystal portions to be joined. This phenomenon is marked when a crystalline plastic is used, and becomes even more marked particularly when a liquid crystal polymer (LCP) as an example of a crystalline plastic, is used. That is, a phenomenon of joining being unable to be performed when directions of molecular chains differ in the up-down direction, occurs, a joining force on the inside is weak even if molding can be performed, and practical holding becomes difficult, which are a problem.

Moreover, conventionally, a welding strength of the intersection has been increased by making a temperature of a molten resin even higher and raising activity of the molecules, but when this has been done, an amorphous portion has ended up increasing more than a crystalline portion, and fundamental characteristics of the crystalline plastic have been deteriorated. Furthermore, there is also confirmed a phenomenon that due to a molding temperature being a high temperature, the molded article has ended up warping by contraction during a temperature drop after discharge.

The molded article S in the present embodiment is similar to that on the left side of FIG. 6 in having a parallel cross structure overall, but, as shown on the right side of FIG. 6, the resin material R1 is not formed linearly, but is formed such that part of it is bent. More specifically, the resin material R1 in the first layer extends in the X direction (the first direction) overall, but has alternately formed therein every certain length a pattern WD where it is bent at an angle θ (a first angle) in the Y direction and a pattern WD where it is bent at an angle −θ (a second angle) in the Y direction. The angle el is arbitrarily changeable, and in the example shown on the right side of FIG. 6, θ is 45 degrees. The resin material R1 in the second layer also similarly extends in the Y direction (the second direction) overall, but has alternately formed therein every certain length a pattern WD where it is bent at an angle 90−θ (a third angle) in the X direction and a pattern WD where it is bent at an angle −(90−θ) (a fourth angle) in the X direction.

Now, “extending in the X direction overall” and “extending in the Y direction overall” indicate that a direction in which the resin material R1 is continuously formed (the molding direction) is the X direction or the Y direction. In other words, “extending in the X direction overall” and “extending in the Y direction overall” indicate that a longitudinal direction of the resin material R1 including a plurality of the intersections CR coincides with the X direction or the Y direction. Moreover, the angles at which the resin materials R1 are bent need not all be precisely θ, but may have variation provided that an average angle is θ. That is, the resin materials R1 of the first layer and the second layer have similar patterns, are formed such that their molding directions orthogonally intersect, and are formed such that, at the intersection CR, fellow patterns WD in which the resin materials R1 are bent extending in a third direction, overlap. Therefore, whereas in the case shown on the left side of FIG. 6, fellow resin materials R1 orthogonally intersect at the intersection CR of the resin materials R1 in the first layer and the second layer, on the right side of FIG. 6, fellow resin materials R1 are in a state of being joined in parallel at the intersection CR. As a result, in a portion where joining is performed in parallel, fellow molecular chains are also in parallel and therefore closely adhere in the up-down direction. As a result, whereas on the left side of FIG. 6, shapes described by the resin materials R1 of the first layer and the second layer are all rectangles when viewed from above, in the case of the right side of FIG. 6, there is a shape of the kind where octagons and rectangles are alternately aligned when viewed from above. When the resin materials R1 are joined in parallel in the up-down direction in this way, orientations of the molecular chains in the intersection CR can be matched, and, compared to when the resin materials R1 intersect orthogonally, welding strength can be increased.

FIG. 7 is a plan view showing another example of a structure of the molded article S formed by the first embodiment. The left side of FIG. 7 shows the case where a conventional molded article S manufactured by the three-dimensional molding device has formed therein a parallel cross structure in which the resin materials R1 are arranged linearly without a gap, and at the intersection CR of the resin materials R1 of the first layer and the second layer, fellow resin materials R1 intersect orthogonally to be joined in the up-down direction. The right side of FIG. 7 shows another example of the molded article S in the present embodiment, and the resin materials R1 in the first layer and the second layer are formed so as to continuously extend with, respectively, the X direction and the Y direction as their molding directions overall. However, in the first layer, the resin material R1 has a zigzag shape in which it is alternately bent at an angle θ and an angle −θ every certain length, and in the second layer, the resin material has a zigzag shape in which it is alternately bent at an angle 180−θ and an angle −(180−θ) every certain length. θ is arbitrarily changeable, and in the example shown on the right side of FIG. 7, θ is 90 degrees. Furthermore, portions representing sides of the zigzag shapes of the resin materials R1 in the first layer and the second layer are arranged so as to overlap in parallel. That is, in the example on the left side of FIG. 7, fellow resin materials R1 are overlapped intersecting orthogonally at the intersection CR, but by configuring such that the resin material R1 is bent at a right angle as on the right side of FIG. 7, fellow resin materials R1 of the upper and lower layers are configured so as to overlap in parallel. As a result, orientations of the molecular chains in the intersection CR can be equal, and, compared to the case on the left side of FIG. 7, welding strength of the resin materials R1 can be increased. Moreover, by arranging the resin materials R1 without a gap, the number of intersections CR where the resin materials R1 are joined in parallel is further increased in a unit area, and welding strength of the resin materials R1 can be even further increased, compared to the case on the right side of FIG. 6.

Thus, due to the present embodiment, by setting discharge patterns so that places where joining is performed in parallel can be made in the intersection CR of the resin materials in the up-down direction, adhesion increases in the intersection CR due to equal orientations of the molecular chains of the resin materials, and a molded article S having higher welding strength can be obtained. Moreover, because adhesion of the resin materials gets to increase without any need for molding temperature to be raised, molding at a lower temperature is enabled. By molding temperature being decreased, distortion stress in the molded article due to contraction during temperature drop after discharge can also be reduced, and warping of the molded article can also be prevented.

For simplification of description, FIGS. 6 and 7 illustrate cases where one each respectively of first layers and second layers are overlapped. However, the present invention is not limited to this, and a desired molded article S can be obtained by alternately overlapping an arbitrary number of the first layers and the second layers.

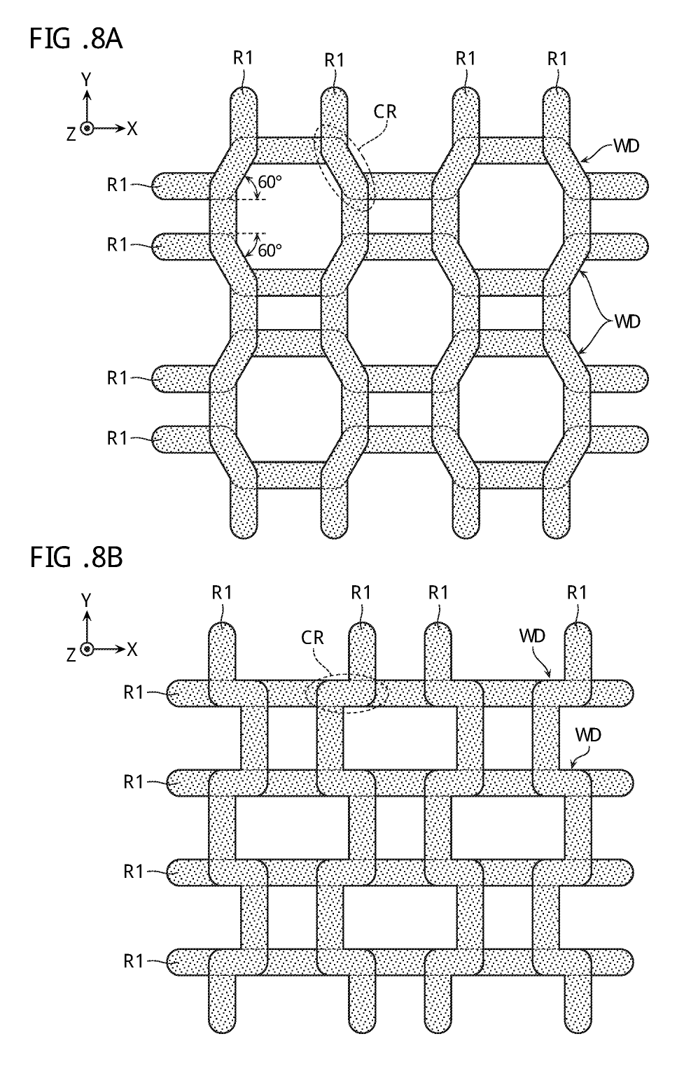

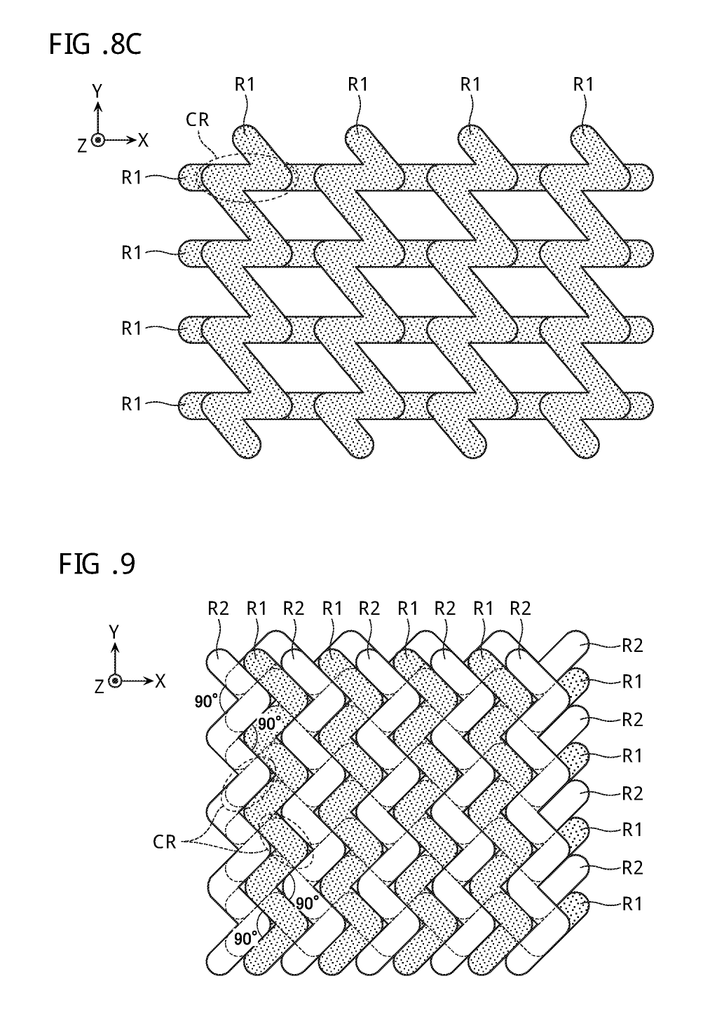

FIG. 8A is a modified example of the example shown on the right side of FIG. 6. As mentioned above, θ is arbitrarily changeable, and FIG. 8A illustrates the case where θ is 60 degrees. Even in this case, the intersection CR of the resin materials R1 in the up-down direction has a structure in which fellow bent patterns WD are joined in parallel, hence welding strength of the fellow resin materials R1 can be increased.

Moreover, although the examples of FIGS. 6, 7, and 8A showed cases where the resin material R1 is non-linear in both the first layer and the second layer, it is also possible to configure such that the resin material is formed linearly in either one of the layers, the resin material is formed non-linearly in the other layer, and the resin materials overlap in parallel at the intersection CR. For example, as shown in FIG. 8B, the resin material R1 in the first layer is formed linearly extending in the X direction. On the other hand, the resin material R1 in the second layer is formed so as to extend in the Y direction overall, and has a pattern WD of the kind where a U shape and a reverse U shape are alternately formed. Furthermore, the pattern WD where part of the U shape is directed in the X direction is overlapped in parallel on the resin material R1 of the first layer. Although the example of FIG. 8B shows the case where projections of the U shapes face each other, all the projections may be configured to be oriented to the same direction. Moreover, as shown in FIG. 8C, it is also possible that while the resin material R1 in the first layer is formed linearly extending in the X direction, the resin material R1 in the second layer is formed in a saw-tooth shape extending in the Y direction, whereby a place where part of the saw-tooth shape is directed in the X direction is overlapped in parallel on the resin material R1 of the first layer. Even in the examples of FIGS. 8B and 8C, the fellow resin materials R1 overlap in parallel at the intersection CR.

Furthermore, although cases have been described where, as mentioned above, the fellow resin materials R1 are joined in parallel at all of the intersections CR of the resin materials R1 of the first layer and the second layer, the present invention is not limited to this, and, even when adopting a structure where at some of the intersections CR, the resin materials R1 intersect, and at some of the intersections CR, the resin materials R1 are joined in parallel, it is possible for adhesion of the resin materials R1 to be improved more compared to when the intersections CR of the resin materials R1 all intersect orthogonally.

### Second Embodiment

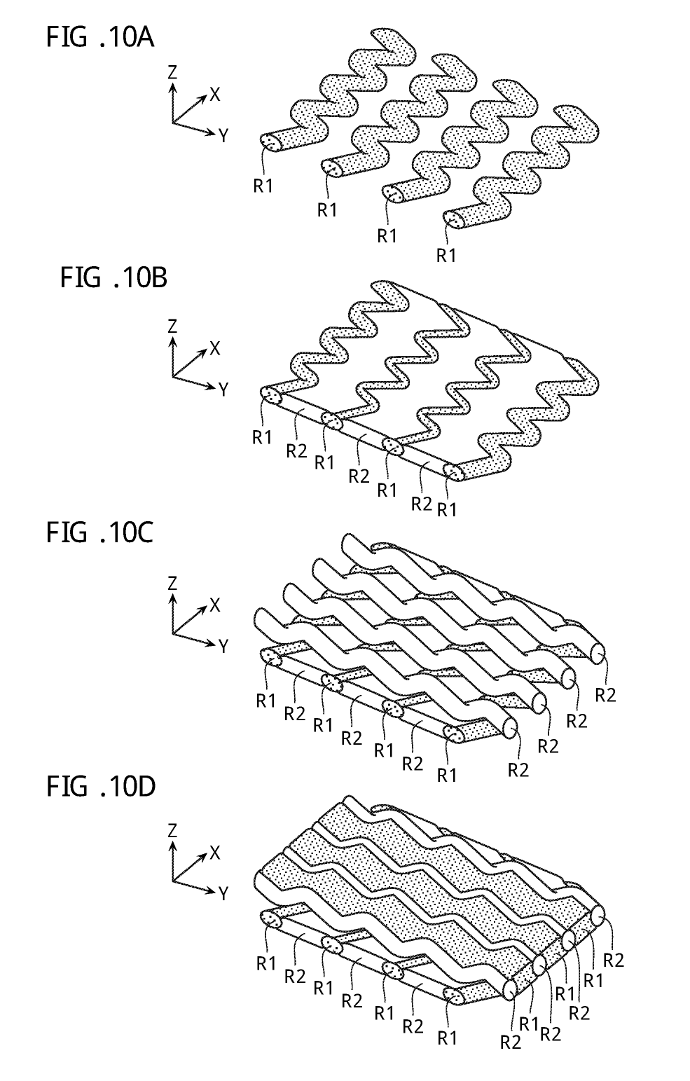

Next, a molded article S and a molding procedure of the same according to a second embodiment will be described with reference to FIGS. 9 and 10A to 10D. A three-dimensional molding device according to the second embodiment is similar to that of the first embodiment, hence a duplicated description thereof will be omitted. In the second embodiment, contrary to in the first embodiment, the molded article S is molded using a plurality of kinds of resin materials. For simplification of explanation, in the example of FIGS. 9 and 10A to 10D, the case where two kinds of resin materials R1, R2 (a first resin material, a second resin material) are used to mold the molded article S will be described, but it goes without saying that three or more kinds of resin materials may be employed.

FIG. 9 is a plan view of the molded article S according to the second embodiment. In the molded article S according to the present embodiment, similarly to on the right side of FIG. 7, although the resin material R1 and the resin material R2 form a parallel cross structure overall, the resin materials R1, R2 are not formed linearly. In one layer (the first layer), the resin material R1 extends in the X direction (the first direction) overall, and is formed in a zigzag shape in which it is alternately bent at angles θ, −θ every certain length. In a layer one above that layer (the second layer), the resin material R1 extends in the Y direction (the second direction) intersecting the X direction overall, and is configured in a zigzag shape in which it is alternately bent at an angle 180−θ and an angle −(180−θ) every certain length. θ is arbitrarily changeable, and in the example shown in FIG. 9, θ is 90 degrees. In the one layer (the first layer), at a position sandwiched by the resin materials R1, the resin material R2 also similarly extends in the X direction (the first direction) overall, and is formed in a zigzag shape in which it is alternately bent at an angle θ and an angle −θ every certain length. And, in the layer one above that layer (the second layer), at a position sandwiched by the resin materials R1, the resin material R2 also similarly extends in the Y direction (second direction) intersecting the X direction overall, and is configured in a zigzag shape in which it is alternately bent at an angle 180−θ and an angle −(180−θ) every certain length. For the resin material R2 also, θ is 90 degrees. Furthermore, portions representing sides of the zigzag shapes of the resin materials R1, R2 in the first layer and the second layer are arranged in positions by which they respectively overlap in parallel. Due to this kind of structure, even supposing that a joining force (in a transverse direction) between the resin materials R1 and R2 of different kinds is weak, if a joining force in the up-down direction between identical resin materials in the above-mentioned kind of parallel cross structure is strong, then strength of the molded article S can be configured sufficiently high.

In the example of FIG. 9, the combination ratio of the resin materials R1, R2 is assumed to be 1:1, and the resin materials R1, R2 are arranged alternately in one layer. As will become clear also from later-given descriptions, the number of resin materials, the combination ratio of the resin materials, the number of layers, and so on, are merely exemplary, and are variously changeable according to a required specification, and so on, of the molded article. Note that although FIG. 9 illustrates a structure in which the resin materials R1, R2 make contact without a gap in one layer, the structure of the molded article S is not limited to this. A gap may occur between the resin materials adjacent in the transverse direction in one layer. Moreover, although illustration thereof is omitted, it is also possible for the resin materials R1, R2 to each be formed in a structure similar to the structure shown on the right side of FIG. 6. In this case also, although the combination ratio of the resin materials R1, R2 is arbitrarily changeable, the fellow resin materials R1 and fellow resin materials R2 in the up-down direction are arranged so that they can be joined in parallel at the parallel cross-structured intersection CR.

Moreover, by using resin materials of different kinds combined in one molded article S in this way, a molded article combining characteristics of the different kinds of resin materials can be provided. For example, it also becomes possible to have advantages of a first resin material and compensate for disadvantages of the first resin material by advantages of a second resin material.

The molding procedure of the molded article S shown in FIG. 9 will be described with reference to FIGS. 10A to 10D. First, in the first layer, as shown in FIG. 10A, the resin materials R1 are formed with the X direction (the first direction) as their molding direction, in a zigzag shape in which they are alternately bent an angle θ and an angle −θ every certain length, with an arrangement pitch of 1:1. In this case, θ is 90 degrees.

Then, as shown in FIG. 10B, the resin materials R2 are similarly formed with an arrangement pitch of 1:1, so as to fill gaps of the resin materials R1. In this case, the resin materials R2 can be formed so as to fill the gap of two resin materials R1, along outer peripheral shapes of the resin materials R1. Thereby, joining between the resin materials R1 and R2 can be strengthened.

Next, as shown in FIG. 10C, in the second layer, the resin materials R2 are formed with the Y direction (second direction) as their molding direction, in a zigzag shape in which they are alternately bent an angle θ and an angle −θ every certain length, with an arrangement pitch of 1:1. In this case, side portions of the zigzag shapes of the resin materials R2 in the first layer and the second layer are configured so as to overlap in parallel.

Then, as shown in FIG. 10D, the resin materials R1 are similarly formed with an arrangement pitch of 1:1, so as to fill gaps of the resin materials R2 in the second layer. In this case, the resin materials R1 can be formed so as to fill the gaps of two resin materials R2, along outer peripheral shapes of the resin materials R2. Furthermore, side portions of the zigzag shapes of the resin materials R1 in the first layer and the second layer are configured to overlap in parallel. Thereby, respective adhesion of fellow resin materials R1 and fellow resin materials R2 increases, and, moreover, joining between the resin materials R1 and R2 can be strengthened.

Due to the above-mentioned procedure shown in FIGS. 10A to 10D, the molded article S shown in FIG. 9 is completed.

Note that in FIGS. 10C and 10D, it is configured such that in the second layer, the resin materials R2 are formed first with a certain arrangement pitch, and the resin materials R1 are then filled into gaps of the resin materials R2, that is, a forming order of the resin materials R1, R2 is made different for the first layer and the second layer. Alternatively, it is also possible to configure such that in all of the layers, a specific resin material (for example, the resin material R1) is formed first, and another resin material (for example, the resin material R2) is then filled into the gap.

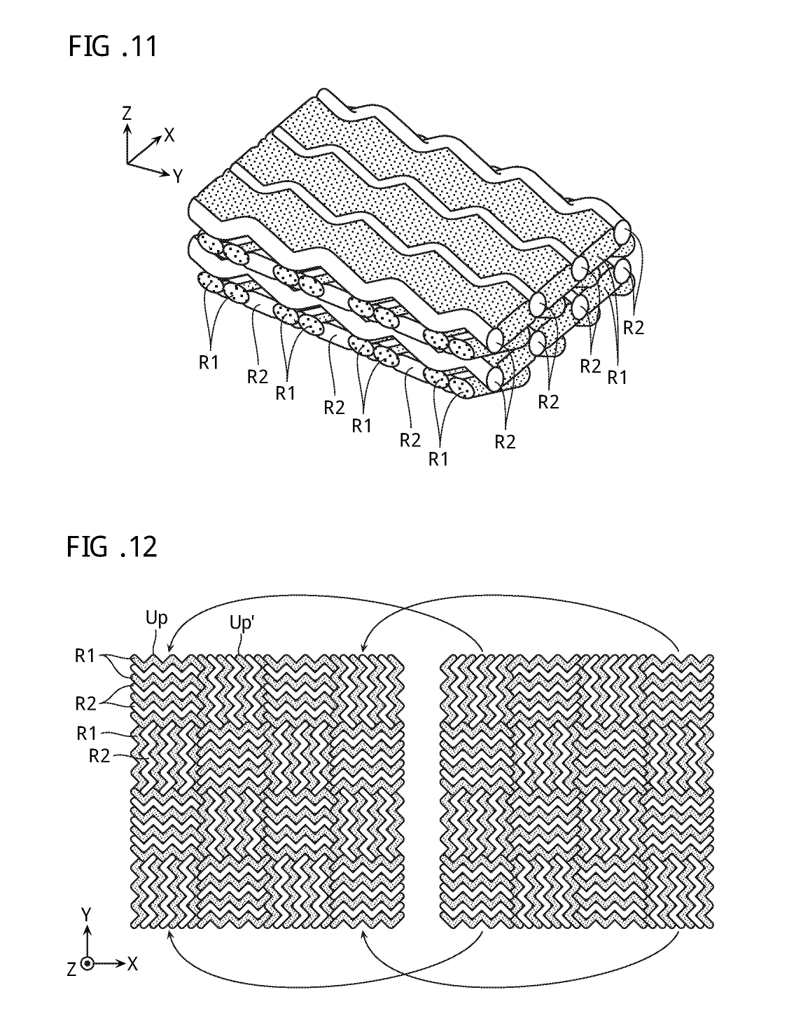

Although FIGS. 9 and 10A to 10D illustrate the molded article S where the combination ratio of the resin materials R1 and R2 is 1:1, it goes without saying that the molded article S manufactured by the present embodiment is not limited to this. For example, the combination ratio is not limited to 1:1, and another desired ratio may be set. For example, FIG. 11 shows the case where the combination ratio of the resin materials R1 and R2 is 2:1. Furthermore, it is also possible for the combination ratio to be changed gradually or continuously in the Z direction and/or a horizontal direction (within the same layer).

The molded article S where the combination ratio of the resin materials R1, R2 is 2:1 can be formed by repeatedly forming two resin materials R1 and one resin material R2 as in FIG. 11. However, it is not limited to this, and, for example, the combination ratio 2:1 can be obtained also by repeatedly forming four resin materials R1 and two resin materials R2. A pattern of repetition of the resin materials R1, R2 like that of FIG. 11 is expressed as a “2:1 repetition pattern”. Moreover, although illustration thereof is omitted, the case where, respectively, m and n each of the resin materials R1 and R2 are repeatedly formed is expressed as an m n repetition pattern. This repetition pattern is expressed by repetition pattern data PR which will be mentioned later.

Even in the molded article S according to the second embodiment, it is possible for a plurality of kinds of resin materials to each be formed like the structure of FIG. 6. In addition, it is also possible to configure such that, similarly to the cases described by FIGS. 8B and 8C, the resin material is formed linearly in either one of the first layer and the second layer and is formed non-linearly in the other layer, whereby the resin materials at the intersection CR are joined in parallel. Moreover, even in the present embodiment, fellow resin materials need not be joined in parallel at all of the intersections CR, but may be configured such that, at some of the intersections CR, they intersect or orthogonally intersect, and at some of the intersections CR, they are joined in parallel.

Moreover, in the above-mentioned examples, the structure in one molded unit Up (or, the structure of the molded article S when division into molded units is not performed) is described. When the molded article S is divided into a plurality of molded units Up, the molded article S in one layer is configured as in FIG. 12, for example (FIG. 12 is the case where the combination ratio is 1:1, but this is merely an example, and it goes without saying that a combination ratio other than that illustrated may be adopted).

As shown in FIG. 12, the molding space may be divided into a plurality of molded units Up as required. One molded unit Up is further divided into a plurality of slice data, and molding is performed for each single layer corresponding to the slice data. For example, when molding of a first layer of one molded unit Up finishes, next, molding of a first layer of a molded unit (for example, the molded unit Up′ of FIG. 12) adjacent to this molded unit Up is started.

In this case, in one molded unit Up, the resin materials R1, R2 are formed with one direction (for example, the X direction) as their molding directions so as to be adjacent to each other with a certain arrangement pitch, but in the adjacent molded unit Up′, in the same layer, the resin materials R1, R2 are formed continuously with a different direction (for example, the Y direction) as their molding directions. This is repeated in each layer, whereby a large number of structures like that shown in FIG. 9, for example, are formed.

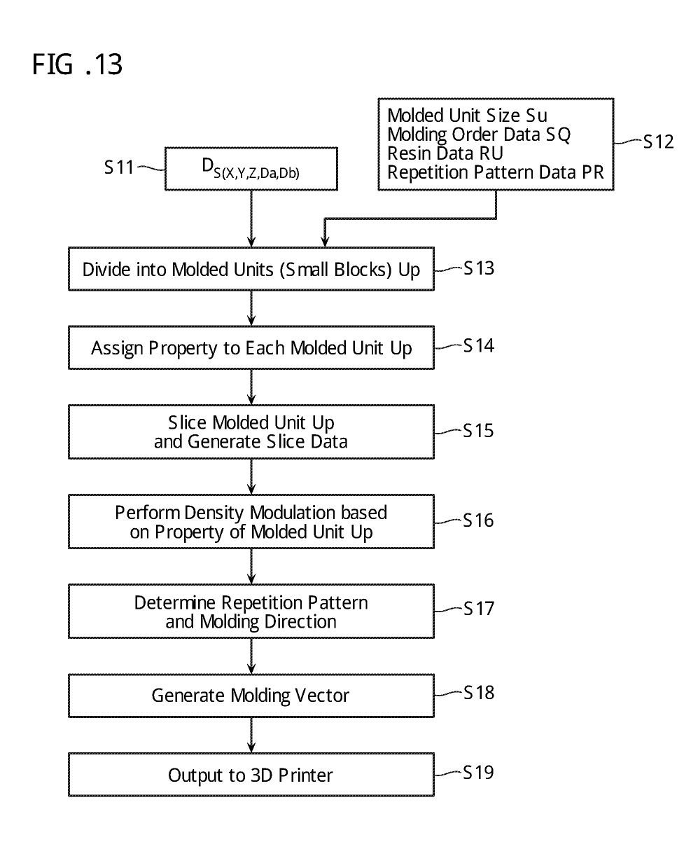

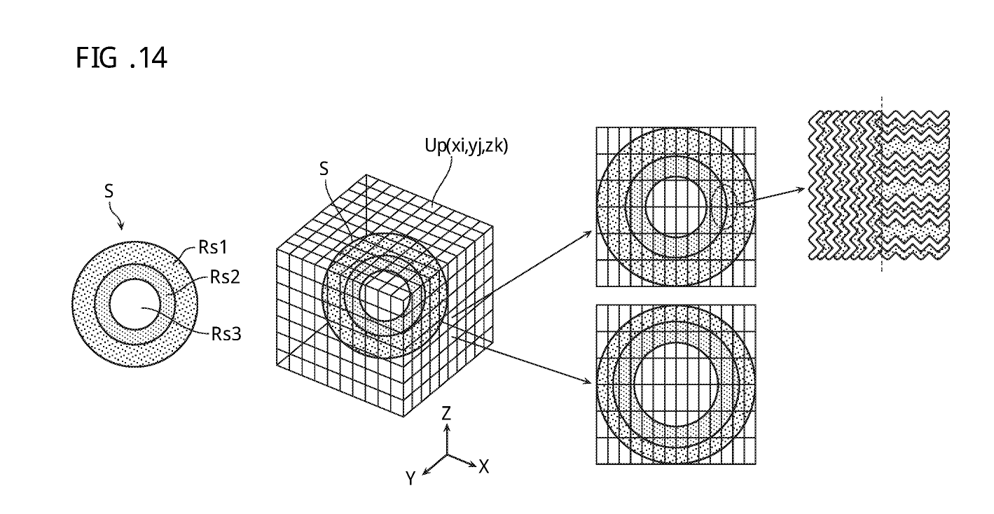

Next, a specific molding procedure of the molded article S employing the three-dimensional molding device of the present embodiment will be described with reference to the flowchart of FIG. 13 and the schematic view of FIG. 14.

First, the computer 200 receives the master 3D data relating to a form of the molded article S, from outside (S11). Assumed here is a molded article S of the kind shown on the left side of FIG. 14. The molded article S illustrated in this FIG. 14 is a triply structured spherical molded article, and is configured from: an outer peripheral section Rs1 configured mainly from the resin material R1; an inner peripheral section Rs2 in which the resin material R1 and the resin material R2 are mixed; and a central section Rs3 configured mainly from the resin material R2.

The master 3D data includes: coordinates (X, Y, Z) at each configuring point of the molded article S; and data (Da, Db) indicating the combination ratio of the resin materials R1, R2 at the configuring point. Hereafter, data of each configuring point will be notated as Ds (X, Y, Z, Da, Db). Note that when there are three or more kinds of resin materials used, data Dc, Dd, . . . indicating the combination ratios of the relevant resin materials are added to the configuring point data Ds, in addition to the data Da, Db.

Moreover, the likes of a size Su of a molded unit Us, molding order data SQ indicating a procedure for molding a plurality of the molded units Us in one layer, resin data RU specifying the plurality of kinds of resin materials used, and repetition pattern data PR indicating how the plurality of kinds of resin materials are repeatedly formed (data indicating in what pattern the plurality of kinds of resin materials are formed), are outputted or instructed by the molding instruction section 204 (S12). In this case, part or all of necessary data is inputted to the molding instruction section 204 from outside using an input device such as a keyboard or mouse, or is inputted to the molding instruction section 204 from an external storage device.

Next, in the spatial filter processing section 201, the molding space indicated by the master 3D data is divided into a plurality of molded units Up based on the instructed molded unit size Su (S13). As shown in the central section of FIG. 14, the molded unit Up is a rectangular molded space formed by dividing the molding space of the molded article S in the XYZ directions.

Each of the divided molded units Up is assigned with property data reflecting the corresponding configuring point data Ds (X, Y, Z, Da, Db) (S14). Whereas the master 3D data is continuous value 3D data indicating the shape of the molded article S, data of each of the molded units Up is discrete value 3D data indicating the shape of each of the molded units Up.

Next, data of the molded unit Up assigned with this kind of property data is sent to the slicer 202. The slicer 202 further divides this data of the molded unit Up along the XY plane, and generates a plurality of sets of slice data (S15). The slice data is assigned with the previously mentioned property data.

Then, the molding scheduler 203 executes density modulation on each of the slice data, based on the property data included in each of the slice data (S16). Density modulation refers to a calculation operation that determines a forming ratio of the resin materials R1 and R2 in the relevant slice data, based on the previously mentioned combination ratio (Da, Db). In the example shown in FIG. 14, the right side of FIG. 14 is an enlarged view of a boundary portion between the outer peripheral section Rs1 and the inner peripheral section Rs2, and is formed by making the combination ratios of the resin materials R1, R2 different.

In addition, the molding scheduler 203 determines the repetition pattern and the molding direction of the resin materials R1 and R2, based on a calculation result of the previously mentioned density modulation and on the molding order data SQ and repetition pattern data PR received from the molding instruction section 204 (S17). In order to obtain the above-mentioned parallel cross structure, the molding direction in the slice data of one layer is set to a direction intersecting that of the slice data in the layer one below that layer. Although illustration thereof is omitted, the molding directions shown on the right side of FIG. 14 and the molding directions of the resin materials R1, R2 in the layer one below that shown are configured so as to intersect orthogonally. Furthermore, the resin materials R1, R2 are formed in a pattern extending in a zigzag shape, so as to have a portion where fellow resin materials overlap in parallel in the upper and lower layers.

Then, the molding vector generating section 205 generates a molding vector, based on the molding direction data determined in the molding scheduler 203 (S18). This molding vector is outputted to the 3D printer 100 via the driver 300, and a molding operation based on the master 3D data is executed (S19). Moreover, the plurality of molded units Up are formed based on the molding order data SQ instructed by the molding instruction section 204, and finally, the molded article S is formed in the entire molding space.

[Advantages]

As described above, due to the three-dimensional molding device of the present embodiment, molding heads 24A, 24B are controlled such that in a first layer, a plurality of kinds of resin materials are formed along a first direction, and the plurality of kinds of resin materials are aligned in a second direction intersecting the first direction. Moreover, the molding heads 25A, 25B are controlled such that in a second layer provided above the first layer, the plurality of kinds of resin materials are formed along a third direction intersecting the first direction, the plurality of kinds of resins are aligned in a fourth direction intersecting the third direction, and, furthermore, the respective resin materials have a portion where they overlap in parallel in the upper and lower layers. As a result, even when, in a molded article, the plurality of kinds of resin materials are incorporated in a so-called parallel cross structure and a molded article that complexly employs the plurality of materials is generated, there exist points where identical resin materials overlap in parallel in a height direction whereby orientations of their molecular chains are equal, hence joining between the identical resin materials can be strengthened, and joining between the differing plurality of resin materials can also be comprehensively strengthened. Furthermore, equal orientations of the molecular chains in the resin materials makes it possible for the adhesion of fellow resin materials to be increased, even when molding at a lower temperature. Decreasing the molding temperature makes it possible for distortion stress within the molded article to be reduced, and also enables warping to be prevented.

Moreover, using a plurality of kinds of resin materials in one molded article makes it possible to provide a molded article combining advantages of the plurality of kinds of resin materials. For example, generally, in a material, strength and flexibility have conflicting characteristics, and development and production of a material combining the two is considered to be extremely difficult on a commercial scale. However, due to the molding device of the present invention, by configuring a parallel cross structure employing, for example, a resin material R1 having high strength and a resin material R2 having high flexibility, it is possible to achieve a resin material having high strength and high flexibility.

Moreover, by making a configuring ratio of the resin material R1 and the resin material R2 variable, it is also possible for the strength and flexibility characteristics to be made freely variable.

While certain embodiments have been described, these embodiments have been presented by way of examples only, and are not intended to limit the scope of the inventions. Indeed, the novel methods and systems described herein may be embodied in a variety of other forms: furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

For example, in the above-described embodiments, a moving mechanism of the 3D printer 100 includes: the guide shafts 15 extending perpendicularly to the molding stage 13; the raising-and-lowering table 14 that moves along the guide shafts 15; and the XY table 12. However, the moving mechanism of the 3D printer 100 of the present invention is not limited to this. For example, it is possible to adopt a moving mechanism in which the XY table 12 where the molding heads 25A, 25B are mounted is configured fixed, and the molding stage 13 is configured able to be raised and lowered. Moreover, in the above-described embodiments, respectively independent configurations are shown for the 3D printer 100, the computer 200 and driver 300. However, it is also possible for the computer 200 and the driver 300 to be built in to the 3D printer 100.

### Description of Reference Numerals

100 3D printer
200 computer
300 driver
11 frame
12 XY stage
13 molding stage
14 raising-and-lowering table
15 guide shaft
21 frame body
22 X guide rail
23 Y guide rail
24A, 24B filament holder
25A, 25B molding head
31 frame body
34, 35 roller
38A, 38B filament
201 spatial filter processing section
202 slicer
203 molding scheduler
204 molding instruction section
205 molding vector generating section
WD pattern
CR intersection

1. A molded article having a repeated structure of a first layer and a second layer, wherein
the first layer has a resin material that continuously extends in a first direction overall,
the second layer provided above the first layer has a resin material that continuously extends in a second direction intersecting the first direction overall, and
the resin material of the first layer and the resin material of the second layer extend, at their intersection, in a third direction that intersects at least one of the first direction and the second direction.

2. The molded article according to claim 1, wherein
the first direction and the second direction intersect orthogonally,
the resin material in the first layer alternately has a pattern of being bent at a first angle with respect to the first direction and a pattern of being bent at a second angle in an opposite direction to the first angle with respect to the first direction every certain length, the resin material in the second layer alternately has a pattern of being bent at a third angle with respect to the first direction and a pattern of being bent at a fourth angle in an opposite direction to the third angle with respect to the first direction every certain length, and, by the fellow patterns of the resin materials joining in an up-down direction, a shape described by the resin materials of the first layer and the second layer alternately form an octagon and a rectangle, when viewed from above.

3. A molded article having a repeated structure of a first layer and a second layer that include a plurality of kinds of resin materials, wherein
the first layer has
a first resin material that continuously extends in a first direction overall, and is arranged with a gap in a second direction intersecting the first direction, and
a second resin material that is other than the first resin material, continuously extends in the first direction overall, and includes a portion arranged in the gap,
the second layer provided above the first layer has
the first resin material that continuously extends in a third direction intersecting the first direction, and is arranged with a gap in a fourth direction intersecting the third direction, and
the second resin material that continuously extends in the third direction, and includes a portion arranged in the gap,
the first resin material of the first layer and the first resin material of the second layer extend, at their intersection, in a fifth direction that intersects at least one of the first direction and the third direction, and
the second resin material of the first layer and the second resin material of the second layer extend, at their intersection, in a sixth direction that intersects at least one of the first direction and the third direction.

4. The molded article according to claim 1, wherein
the first layer and the second layer are each divided into a plurality of units, and in the plurality of units adjacent to each other, directions that the resin materials continuously extend differ from each other.

5. The molded article according to claim 1, wherein
the resin material is a crystalline resin.

6. The molded article according to claim 5, wherein
the resin material is a liquid crystal polymer.

7. The molded article according to claim 3, wherein
the first layer and the second layer are each divided into a plurality of units, and in the plurality of units adjacent to each other, directions that the resin materials continuously extend differ from each other.

8. The molded article according to claim 3, wherein
the resin material is a crystalline resin.

9. The molded article according to claim 8, wherein
the resin material is a liquid crystal polymer.

10. A method for controlling a three-dimensional molding device, the three-dimensional molding device comprising a molding head,
the method comprising:
a step of controlling the molding head such that, in a first layer, a resin material continuously extends in a first direction overall; and
a step of controlling the molding head such that, in a second layer provided above the first layer, the resin material continuously extends in a second direction intersecting the first direction overall, and
control being performed such that the resin material of the first layer and the resin material of the second layer extend, at their intersection, in a third direction that intersects at least one of the first direction and the second direction.

11. A method for controlling a three-dimensional molding device, the three-dimensional molding device comprising a molding head,
the method comprising:
a step of controlling the molding head such that, in a first layer, a first resin material continuously extends in a first direction and is arranged with a gap in a second direction intersecting the first direction, and a second resin material other than the first resin material continuously extends in the first direction and is arranged in the gap; and
a step of controlling the molding head such that, in a second layer provided above the first layer, the first resin material continuously extends in a third direction intersecting the first direction, and is arranged with a gap in a fourth direction intersecting the third direction, and
control being performed such that the first resin material of the first layer and the first resin material of the second layer extend, at their intersection, in a fifth direction that intersects at least one of the first direction and the third direction, and
the method comprising
a step of controlling the molding head such that, in the second layer provided above the first layer, the second resin material is arranged in the gap so as to continuously extend in the third direction overall, and
control being performed such that the second resin material of the first layer and the second resin material of the second layer extend, at their intersection, in a sixth direction that intersects at least one of the first direction and the third direction.

12. The method for controlling according to claim 11, further comprising
a step of receiving molded article data including coordinate data and combination ratio data that expresses a combination ratio of the plurality of kinds of resin materials at a position indicated by the coordinate data to control the molding head based on the molded article data.

13. The method for controlling according to claim 12, further comprising:
a step of dividing into a plurality of molded units a region where the molded article is formed;
a step of assigning to each of the plurality of molded units property data corresponding to the corresponding molded article data; and
a step of determining density modulation and molding direction of each of the plurality of kinds in each of the molded units, based on the property data.

14. A three-dimensional molding device, comprising:
a molding stage on which a molded article is placed;
a raising-and-lowering section which is movable in at least a perpendicular direction with respect to the molding stage;
a molding head which is mounted in the raising-and-lowering section and receives supply of a resin material; and
a control section that controls the raising-and-lowering section and the molding head,
wherein
the control section controls the molding head such that, in a first layer, the resin material continuously extends in a first direction overall, and
the control section further controls the molding head such that, in a second layer provided above the first layer, the resin material continuously extends in a second direction intersecting the first direction overall, and such that the resin material of the first layer and the resin material of the second layer extend, at their intersection, in a third direction that intersects at least one of the first direction and the second direction.

15. A three-dimensional molding device, comprising:
a molding stage on which a molded article is placed;
a raising-and-lowering section which is movable in at least a perpendicular direction with respect to the molding stage;
a molding head which is mounted in the raising-and-lowering section and receives supply of a plurality of kinds of resin materials which are different each other; and
a control section that controls the raising-and-lowering section and the molding head, wherein
the control section controls the molding head such that, in a first layer, a first resin material of the plurality of kinds of resin materials continuously extends in a first direction overall, and is arranged with a gap in a second direction intersecting the first direction, and such that a second resin material other than the first resin material of the plurality of kinds of resin materials continuously extends in the first direction overall and is arranged in the gap,
controls such that, in a second layer provided above the first layer, the first resin material continuously extends in a third direction intersecting the first direction overall, and is arranged with a gap in a fourth direction intersecting the third direction, and such that the second resin material continuously extends in the third direction overall and is arranged in the gap, and controls the molding head such that the first resin material of the first layer and the first resin material of the second layer extend, at their intersection, in a fifth direction that intersects at least one of the first direction and the third direction, and the second resin material of the first layer and the second resin material of the second layer extend, at their intersection, in a sixth direction that intersects at least one of the first direction and the third direction.

16. The three-dimensional molding device according to claim 15, wherein
the control section
receives molded article data including coordinate data and combination ratio data that expresses a combination ratio of the plurality of kinds of resin materials at a position indicated by the coordinate data, and controls the molding head based on this molded article data.

17. The three-dimensional molding device according to claim 15, wherein
the control section
divides into a plurality of molded units a region where the molded article is formed,
assigns property data corresponding to the corresponding molded article data to each of the plurality of molded units, and
determines density modulation and molding direction of each of the plurality of kinds in each of the molded units, based on the property data.

18. The three-dimensional molding device according to claim 15, wherein
the control section controls the molding head such that, in the first layer, the second resin material is formed after the first resin material has been formed, and, in the second layer, the first resin material is formed after the second resin material has been formed.
